(19) United States
(12) Patent Application Publication
(10) Pub. No.: US 2022/0248080 A1
(43) Pub. Date: Aug. 4, 2022

(54) SYNCHRONIZATION OF MULTI-VIEWER EVENTS CONTAINING SOCIALLY ANNOTATED AUDIOVISUAL CONTENT

(71) Applicant: SCENER INC., Seattle, WA (US)

(72) Inventor: Daniel STRICKLAND, Seattle, WA (US)

(21) Appl. No.: 17/162,462

(22) Filed: Jan. 29, 2021

(51) Int. Cl. H04N 21/43; H04N 21/4788; H04N 21/6587; H04N 21/433; H04N 21/44; H04N 21/25

(52) U.S. Cl. CPC H04N 21/43076; H04N 21/43079; H04N 21/4788; H04N 21/252; H04N 21/4333; H04N 21/44004; H04N 21/6587

(57) ABSTRACT

A system that includes a content distributor, a content synchronization server, and a plurality of viewer computer devices. The content distributor provides original content to the viewer computer devices, where each viewer computer device independently obtains the original content from the content distributor. The viewer computer devices present the original content to viewers. One of the viewer computer devices is set as a host device to control playback of the original content. In response to the host device manipulating the controls of the playback, synchronization information is provided to the other viewer computer devices to mimic the playback on the host device. The viewer computer devices can also generate viewer-reaction content of the viewers during presentation of the original content. The viewer computer devices provide the viewer-reaction content to the content synchronization server to provide to other viewer computer devices.

### TECHNICAL FIELD

The present disclosure is related generally to providing audiovisual content to a viewer, and particularly to synchronizing multi-viewer events with social annotations from other viewers.

### BACKGROUND

### Description of the Related Art

The advent and expansion of personal computing devices and their capabilities have provided viewers with a platform to experience all types of audiovisual content. Likewise, advancements in speed and bandwidth capabilities of cellular and in-home networks have also expanded the viewer's audiovisual experience to nearly everywhere. Enabling viewers to view all types of audiovisual content in ever-expanding areas, however, has caused viewers to become less engaged with other viewers. Historically, if two friends wanted to watch a movie, they would gather at one of their houses and watch the movie. During the movie, the friends could discuss the movie, experience each other's reactions and emotions as the movie progresses, and even react based on their friend's reaction. Unfortunately, the individualistic atmosphere of today's mobile audiovisual content experience has greatly reduced this social component when experiencing audiovisual content. Moreover, in a world of ever-changing personal habits and health concerns, some viewers may have a desire to experience audiovisual content, while maintaining physical separation from others. It is with respect to these and other considerations that the embodiments described herein have been made.

### BRIEF SUMMARY

Briefly described, embodiments are directed toward systems and methods of synchronizing content separately provided to multiple viewers. In some scenarios, viewers are allowed to generate additional content that is to be provided with the original content to other viewers.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

For a better understanding of embodiments of the present disclosure, reference will be made to the following Detailed Description, which is to be read in association with the accompanying drawings.

FIG. 1 is a context diagram of an environment for providing content to viewers in accordance with embodiments described herein;

FIG. 2 is a context diagram of one non-limiting embodiment of computing systems providing original content and viewer-generated content to viewers in accordance with embodiments described herein;

FIG. 3 is a logical flow diagram showing one embodiment of a process by a viewer computer device for synchronizing original content in a multi-viewer event in accordance with embodiments described herein;

FIG. 4 is a logical flow diagram of one embodiment of a process by a content synchronization server for establishing a multi-viewer event in accordance with embodiments described herein; and

FIG. 5 is a system diagram that describes one implementation of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including, but not limited to, the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive, and allows for being based on additional features, functions, aspects, or limitations not described, unless the context clearly dictates otherwise. In addition, throughout the specification, the meaning of “a,” “an,” and “the” include singular and plural references.

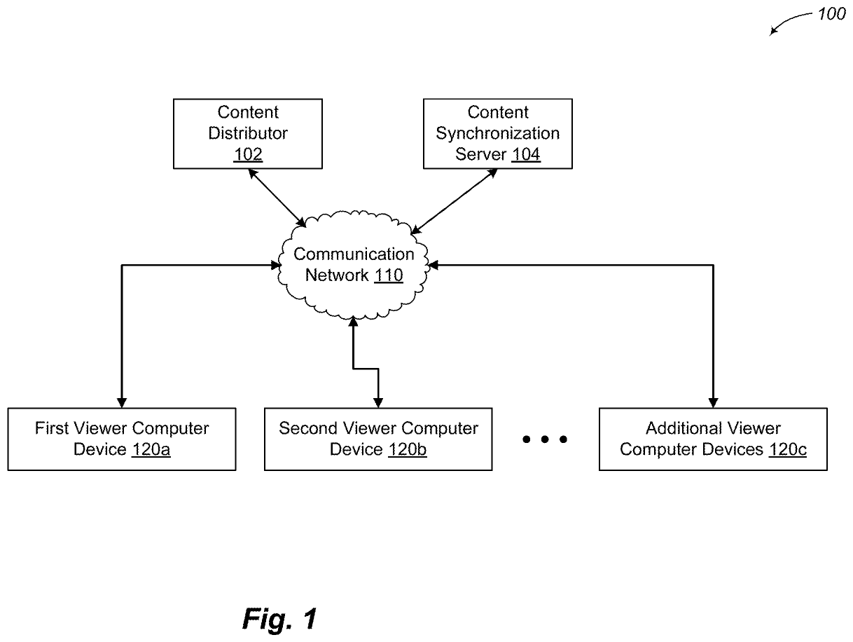

FIG. 1 shows a context diagram of one embodiment of an environment 100 for providing content to a viewer in accordance with embodiments described herein. The environment 100 includes a content distributor 102 and a content synchronization server 104 in communication with a plurality of viewer computer devices 120a-120c via a communication network 110. Examples of the viewer computer devices 120a-120c include smart phones, tablet computers, laptop computers, desktop computers, or other computing devices.

The content distributor 102 is a computer device, such as a server computer, that manages various different types of content for distribution to one or more viewer computer devices 120a-120c. For example, the content distributor 102 provides content to viewer computer devices 120a-120c for presentation to corresponding viewers. In general, the content is described herein as being audiovisual content, but in some embodiments, the content may also be video, audio, text, images, or some combination thereof. The content distributor 102 provides at least original content, and in some embodiments viewer-reaction content, to the viewer computer devices 120a-120c.

Original content is content that is generated or produced to be provided via one or more distribution methods to people (i.e., viewers or users) for viewing. For example, the content distributor 102 may provide original content to viewer computer devices 120a-120c via over-the-air television channels, subscription-based television channels, pay per view, on demand, streaming, or other distribution methods. Examples of original content include movies, sitcoms, reality shows, talk shows, game shows, documentaries, infomercials, news programs, sports broadcasts, commercials, advertisements, user-generated content, or other types of audiovisual content that is intended to be provided to people for viewing.

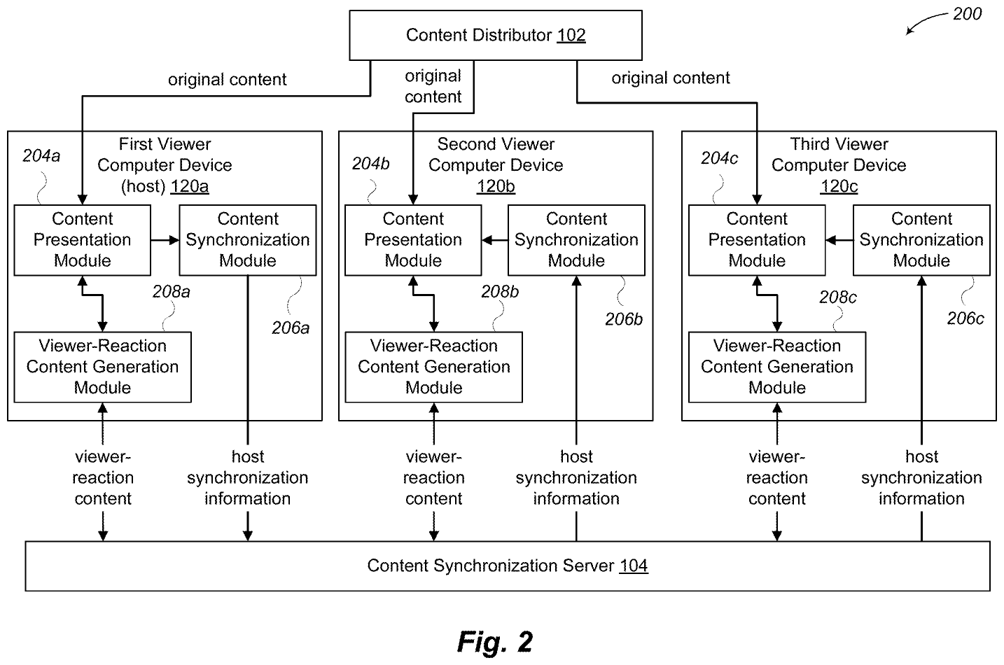

The content synchronization server 104 is a computer device, such as a server computer, that manages the synchronization of presentation the original content on the viewer computer devices 120a-120c. This synchronization is described in more detail below in conjunction with FIG. 2. But briefly, each viewer computer device 120 obtains the original content from the content distributor 102 independent of one another and the content synchronization server 104 coordinates the presentation of the original content on the viewer computer devices 120.

In some embodiments, the content synchronization server 104 also manages various different types of content for distribution to one or more viewer computer devices 120a-120c. For example, the content distributor 102 provides content to viewer computer devices 120a-120c for presentation to corresponding viewers. The content synchronization server 104 provides at least viewer-reaction content, and in some embodiments original content, to the viewer computer devices 120a-120c.

Viewer-reaction content, compared to original content, is audiovisual content that is generated by a viewer computer device 120a-120c of a viewer as that viewer is experiencing original content. Examples of viewer-reaction content include statements or comments, expressions, reactions, movement, text, images, or other types of visual or audible actions by a viewer. One example of viewer-reaction content is a video of a viewer reacting to a surprising scene in the original content. Another example of viewer-reaction content is commentary provided by the viewer discussing the original content. Accordingly, viewer-reaction content can be virtually any type of content of a viewer that is created while the viewer is experiencing original content.

Viewer-reaction content may also include additional data that identifies the playing or presentation position of the original content to the viewer when the viewer-reaction content was generated. In this way, the viewer-reaction content from a first viewer can be synchronized with a particular portion of the original content when presenting the original content and the viewer-reaction content to a second viewer. Thus, the second viewer can experience both the original content and the first viewer's reaction as if they happened in real time with the presentation of the original content to the second viewer.

The viewer computing devices 120a-120c receive original content from the content distributor 102 and present the original content to corresponding viewers. The viewer computer device 120 sends a request to the content distributor 102 for original content. In some embodiments, the viewer computer devices 120a-120c also receive viewer-reaction content from the content synchronization server 104 to be presented along with the original content so that the corresponding viewer of the viewer computer devices 120a-120c can experience other viewer's reactions, commentary, input, or other discussions about the original content. The viewer computer device 120 sends a request to the content synchronization server 104 for one or more viewer-reaction content to present along with the original content. The content synchronization server 104 provides such viewer-reaction content to the viewer computer device 120, which then overlays or otherwise combines the viewer-reaction content with the original content received from the content distributor 102 based on a timestamp associated with the viewer-reaction content indicating where in the presentation of the original content to present the viewer-reaction content. An example of generating and presenting viewer-reaction content is described in PCT Patent Application No. PCT/US2019/025037, filed Mar. 29, 2019 (referred to herein as application '037), having a priority of U.S. Patent Application No. 62/650,499, filed Mar. 30, 2018, both of which are herein incorporated by reference.

The viewer computer devices 120a-120c also capture, record, or otherwise generate viewer-reaction content in response to the corresponding viewer experiencing the original content, which may include viewer-reaction content from one or more other viewers. The viewer computer devices 120a-120c then provide this viewer-reaction content to the content distributor 102 to be provided to other viewer computer devices 120a-120c, such as discussed below in conjunction with FIG. 2. In some other embodiments, the viewer-reaction content may also be generated in response to the viewer reacting to experiencing other viewer-reaction content that is being presented to that viewer. In this way, the original content is annotated with viewer reactions and commentary to create a social experience for each viewer.

Although the content distributor 102 and the content synchronization server 104 are described in some embodiments as separate computing devices, embodiments are not so limited. In other embodiments, the functionality of the content distributor 102 and the content synchronization server 104 may be provided by a single computing device or collection of multiple computing devices working together. For example, in some embodiments, a server computing device may modify or combine the viewer-reaction content with the original content to be provided to the viewer computer device 120 as one or more audiovisual data streams.

Moreover, the content distributor 102 or the content synchronization server 104 may include a plurality of computing devices. For example, the content synchronization server 104 may include a first computing device for managing synchronization of content presentation and a second computing device for managing viewer-reaction content.

The communication network 110 may be configured to couple various computing devices to transmit content/data from one or more computing devices to one or more other computing devices. For example, communication network 110 may be the Internet, X.25 networks, or a series of smaller or private connected networks that carry the content and other data. Communication network 110 may include one or more wired or wireless networks.

FIG. 2 is a context diagram of one non-limiting embodiment of computing systems providing original content and viewer-generated content to viewers in accordance with embodiments described herein. Example 200 shows one example of the flow of content and synchronization information among a content distributor 102, a content synchronization server 104, and a plurality of viewer computer devices 120a-120c.

In this illustrated embodiment, the viewer computer devices 120a-120c include a content presentation module 204, a content synchronization module 206, and a viewer-reaction content generation module 208. Briefly, the content presentation module 204 displays or other otherwise presents original content and previously generated viewer-reaction content to a viewer of a corresponding viewer computer devices 120, the content synchronization module 206 coordinates the timing of the presentation of the original content among the viewer computer devices, and the viewer-reaction content generation module 208 generates viewer-reaction content as the corresponding viewer is experiencing the original content or previously generated viewer-reaction content.

In some embodiments, as described herein, one of the viewer computer devices 120 is set or designated as a host viewer or host viewer computer device. In this example, viewer computer device 120a is set as the host. The content synchronization module 206a monitors or communicates with the content presentation module 204a to determine the current viewing position of the original content being presented by the content presentation module 204a. In various embodiments, the current viewing position is a timestamp, i-frame position, or other indicator of where the viewer is at in the playback of the original content.

The content synchronization module 206a provides the synchronization information (e.g., the current viewing position) to the content synchronization server 104. The content synchronization modules 206b and 206c of the viewer computer devices 120b and 120c, respectively, receive the synchronization information (e.g., current viewing position) from the content synchronization server 104. The content synchronization modules 206b and 206c communicate with the content presentation modules 204b and 204c, respectively, to synchronize their presentation of the original content with the host. In some embodiments, the host viewer computer device 120a may send the synchronization information to the non-host viewer computer devices 120b and 120c without the use of the content synchronization server 104. For example, when the viewer computer devices 120 join a multi-viewer event, their MAC addresses or other identifiers may be shared and used to send and receive synchronization information.

In various embodiments, the content synchronization module 206 may also support, manage, or coordinate the reception of original content from the content distributor 102. For example, if the host viewer computer device 120a pauses the playback of the original content, the content synchronization modules 206b and 206c may instruct the content presentation modules 204b and 204c, respectively, to pause playback but to continue to receive and buffer the original content from the content distributor 102. In this way, the non-host viewer computer devices 120 can store a sufficient amount of the original content to not lag behind the host when playback resumes.

In various embodiments, the content synchronization module 206 also supports or provides various permissions to the other viewer computer devices. For example, the host can indicate which viewer computer devices 120 can capture viewer-reaction content. In at least one embodiment, the viewer computer devices 120 may be given a time limit or open window in which it can capture viewer-reaction content. For example, each viewer computing device 120 may have a five minute non-overlapping window to record viewer-reaction content before permission is provided to a next viewer computing device 120. In at least one embodiment, the host can relinquish or delegate the host condition to another viewer computer device 120.

In some embodiments, the content presentation module 204 may instruct the viewer-reaction content generation module 208 when to generate viewer-reaction content (e.g., if the original content incudes one or more capture-reaction flags). In other embodiments, a corresponding viewer interacts with the viewer-reaction content generation module 208 to provide input indicating when to generate the viewer-reaction content. The viewer-reaction content generation module 208 also associates the viewer-reaction content with a timestamp associated with the original content for the playing or presentation position of the original content when the viewer-reaction content was generated. The viewer-reaction content generation module 208 may also modify the viewer-reaction content to include an identifier of the viewer or the viewer computer device 120.

In various embodiments, the generation of viewer-reaction content may include storing interactions by the host with the content. For example, if the host fast forwards, then the start and end of the fast forward may be stored as a reaction by the host. In this way, viewers who later playback the original content and the viewer-reaction content can also experience the same playback timing of the original content.

The functionality of the content presentation module 204, the content synchronization module 206, and the viewer-reaction content generation module 208 may be provided via applications, content presentation interfaces, web browsers, browser plug-ins, or other computing processes or modules executing on a viewer computer devices 120. Although the content presentation module 204, content synchronization module 206, and the viewer-reaction content generation module 208 are illustrated as being separate, embodiments are not so limited and their functionality may be combined into a single module or separated into additional modules not shown. Similarly, the functionality of the content presentation module 204, the content synchronization module 206, and the viewer-reaction content generation module 208 may be at least partially performed by the content distributor 102 or content synchronization server 104, such as via an interactive web interface. But for ease of discussion, embodiments are described herein with the functionality of the content presentation modules 204a-204c, the content synchronization modules 206a-206c, and the viewer-reaction content generation module 208a-208c being performed by the viewer computer devices 120a-120c, respectively.

Although FIGS. 1 and 2 illustrate and discuss three viewer computer devices 120a-120c and three viewers, embodiments are not so limited. Rather, embodiments described herein may be employed with n viewers, where n viewers is a plurality of viewers.

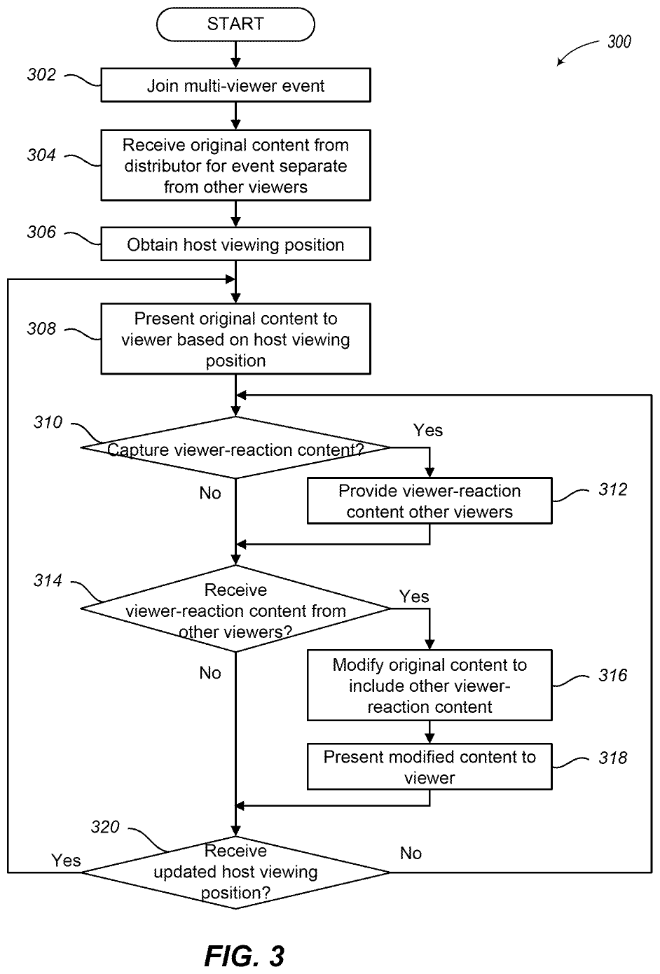

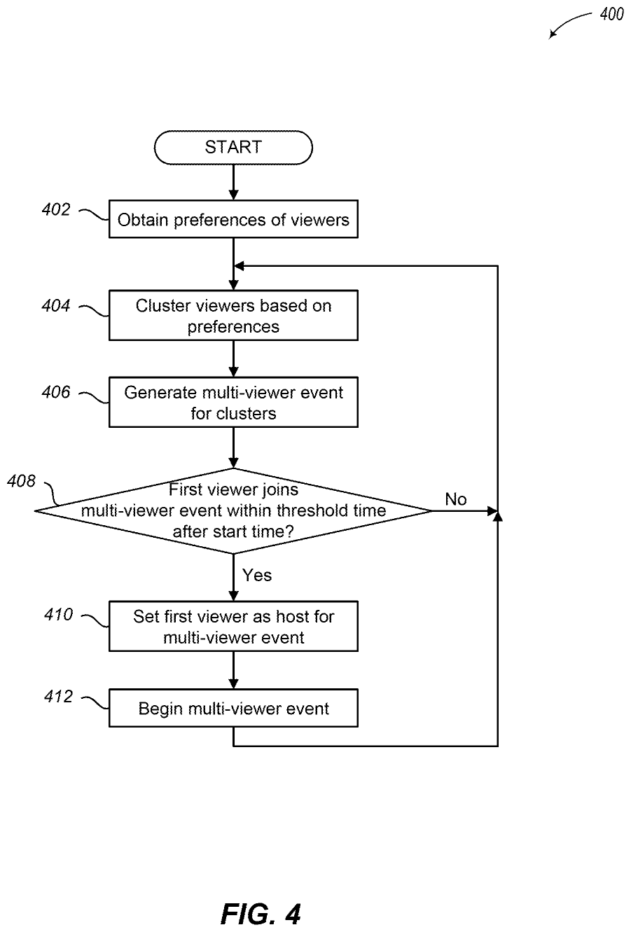

The operation of certain aspects will now be described with respect to FIGS. 3-5. Process 300 described in conjunction with FIG. 3 may be implemented by or executed on one or more computing devices, such as a viewer computer device 120 in FIG. 1; and process 400 described in conjunction with FIG. 4 may be implemented by or executed on one or more computing devices, such as a content synchronization server 104 or content distributor 102 in FIG. 1.

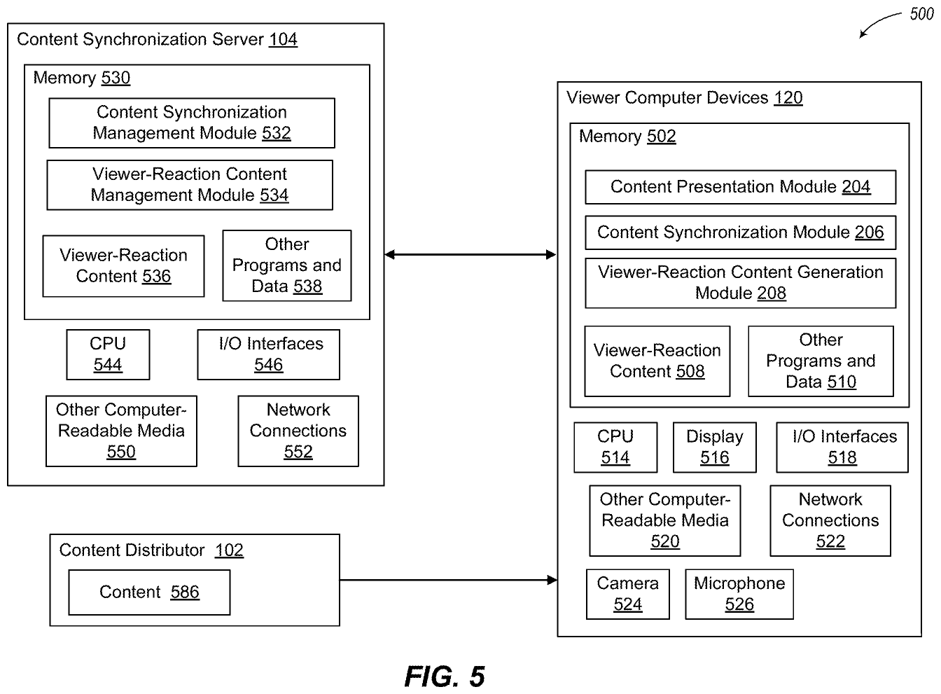

FIG. 3 is a logical flow diagram showing one embodiment of a process 300 by a viewer computer device 120 for synchronizing original content in a multi-viewer event in accordance with embodiments described herein. Process 300 begins, after a start block, at block 302, where the viewer computer device joins a multi-viewer event. In various embodiments, the viewer computer device logs into or accesses a server computer, such as content synchronization server 104 in FIG. 1, which is supporting or maintaining synchronization of a plurality of multi-viewer events. Additional details regarding the creation and joining of a multi-viewer event are discussed in more detail below in conjunction with FIGS. 4 and 5. The viewer can then select an event of the plurality of multi-viewer events to join the selected event.

Process 300 proceeds to block 304, where the viewer computer device receives original content from a content distributor, e.g., content distributor 102 in FIG. 1, for the multi-viewer event. The viewer computer device receives the original content separate from other viewer computer devices participating in the multi-viewer event. In some embodiments, the viewer may have to subscribe or log into particular content distribution system to receive the content. For example, the viewer may log into Netflix®, Disney+®, or Amazon Prime® to receive the content associated with the event. Unlike other content sharing systems, the viewer computer device receives the original content independent of other viewer computer devices.

Process 300 continues at block 306, where a host viewing position is obtained. In various embodiments, the content synchronization server 104 receives a current viewing position within the original content from a host viewer computer device. As described herein, the host viewer computer device may be the first viewer computer device to join the multi-viewer event or it may be the viewer computer device of the viewer that requested, initiated, or otherwise started the multi-viewer event.

Because each viewer computer device associated with the multi-viewer event is receiving the original content independent of each other, the playback of the content may not be synchronized. Likewise, a viewer can join the multi-viewer event after it has started, which results in the viewer being behind the current viewing position of the host. Moreover, as the host viewer interacts with the content, such as fast forwards or rewinds the content, the current viewing position of the host may be different from the current viewing position of the target or non-host viewer.

In various embodiments, the host viewing position is a timestamp of a current play-back position in the original content as the original content is being presented to the host. In other embodiments, the host viewing position may be a particular scene, metadata marker, or other identifier for the current playback position of the original content being presented to the host.

Process 300 proceeds next to block 308, where the original content is presented to the viewer based on the host viewing position. In various embodiments, the playback of the original content is modified based on the host viewing position. In some embodiments, the original content is fast forward, rewound, or otherwise skips to the host viewing position such that current viewing position of the original content is synchronized with the host viewing position. The original content is then fast forward, rewound, or otherwise skipped to the current host viewing position for the presentation of the original content to the viewer to be synchronized with the presentation of the original content to the host.

Process 300 continues next at decision block 310, where a determination is made whether viewer-reaction content is captured by the viewer computing device. In various embodiments, the viewer computer device generates viewer-reaction content of the viewer during presentation of the original content, such as video or audio reactions of the viewer to reacting to the original content (or to viewer reactions provided by other viewer computer devices), text provided by the viewer, emoticons selected by the viewer, etc. One example of a system that captures and generates viewer-reaction content is described in application '037. In various embodiments, a tag, timestamp, or other indicator is generated and associated with the viewer-reaction content to indicate where the viewer-reaction content is captured during presentation of the original content.

If viewer-reaction content is captured by the viewer computer device, then process 300 flows to block 312, where the viewer-reaction content is provided to other viewers; otherwise, process 300 flows to decision block 314.

At block 312, the viewer computer device provides the viewer-reaction content to a remote server, such as content synchronization server 104, which can then be provided to other viewer computer devices for presentation to other viewers during playback of the original content (e.g., as described in application '037). After block 312, process 300 flows to decision block 314.

At decision block 314, a determination is made whether viewer-reaction content from other viewers has been received, which is described in more detail in application '037. In various embodiments, the content synchronization server 104 may provide a tag, metadata, timestamps, or other indicators to the viewer computer device to indicate that there viewer-reaction content from other viewers is available. In some embodiments, the tag may instruct the viewer computer device to fetch the other viewer-reaction content from the content synchronization server during particular presentation times of the original content. The content synchronization server can then provide the corresponding viewer-reaction content to the viewer-computer device. In other embodiments, the content synchronization server may provide the other viewer-reaction content to the viewer-computer device when the viewer joins the multi-viewer event. In this way, the other viewer-reaction content is pre-fetched and can be presented to the viewer based on the tag associated with the reaction content.

If other viewer-reaction content is received, then process 300 flows to block 316, otherwise; process 300 flows to decision block 320.

At block 316, the original content is modified to include the other viewer-reaction content such that the other viewer-reaction content is to be presented to the viewer at a same time in the playback of the original content from when the other viewer-reaction content was captured, which is described in more detail in application '037.

Process 300 proceeds to block 318, where the modified content is presented to the viewer, which is described in more detail in application '037. After block 318, process 300 flows to decision block 320.

At decision block 320, a determination is made whether the viewer computer device has received an updated host viewing position. In various embodiments, the host viewer computer device transmits, to the content synchronization server 104, updates to the host viewing position when the host fast forwards, rewinds, or otherwise skips during presentation of the original content. The content synchronization server 104 then forwards the updated host viewing position to the viewer computer devices associated with the multi-viewer event. In other embodiments, the content synchronization server 104 may periodically or randomly provide the current host viewing position to the viewer computer devices.

If an updated host viewing position has been received, then process 300 loops to block 308 to modify the presentation of the original content to the viewer based on the updated host viewing position; otherwise, process 300 loops to decision block 310 to determine if viewer-reaction content has been captured.

It should be understood that the blocks illustrated in FIG. 3 may be executed in parallel, sequentially, or in a different order than what is described such that the presentation of the original content, or the modified content, to the viewer is synchronized with the presentation of the original content, or the modified content, to the host. Moreover, process 300 may terminate or otherwise return (not illustrated) to a calling process to perform other actions in response to the presentation of the original content ending or the viewer leaving the multi-viewer event.

FIG. 4 is a logical flow diagram of one embodiment of a process 400 by a content synchronization server for establishing a multi-viewer event in accordance with embodiments described herein. Process 400 begins, after a start block, at block 402, where viewing preferences of a plurality of viewers are obtained. In various embodiments, the viewing preferences of a viewer may be obtained by the viewer manually inputting the preferences into the system or they may be obtained based on an analytical analysis of the viewing history of the viewer. Examples of viewing preferences may include, but are not limited to, one or more preferred genres (e.g., comedy, action, drama, etc.), one or more preferred actors or actresses, one or more preferred viewing times (e.g., morning, evening, after 10:00 PM, etc.), one or more preferred types of content (e.g., reality television, live sports, news, etc.), or other preferences. In various embodiments, the viewing preferences may also include various demographic information regarding the viewers.

Process 400 proceeds to block 404, where viewers are clustered based on their viewing preferences. In various embodiments, one or more separate clustering algorithms may be performed to sort, group, or otherwise identify viewers who may be interested in watching similar content at a similar time.

Process 400 continues at block 406, where one or more multi-viewer events are generated for one or more of the clusters. In some embodiments, a separate multi-viewer event is generated for each cluster. A multi-viewer event is the scheduling of a start time in which select viewers can watch or consume select content.

For example, a given cluster of viewers may like action movies on Saturday night and sports on Sunday afternoon. In some situations, the system may generate a single multi-viewer event for those viewers to watch the movie Die Hard at 9:00 PM PDT on Saturday. In other situations, the system may generate a single multi-viewer event for those viewers to watch a professional football game at 1:00 PM PDT on Sunday. In yet other situations, the system may generate both multi-viewer events.

When a multi-viewer event is generated, each viewer associated with the event is provided an invite to the event. In some embodiments, the invite may be a text message, email message, social media message, or other request for the view to participate in an event. In other embodiments, each viewer can utilize a portal, dashboard, or other user interface to see or access events that they have been invited to.

Process 400 proceeds next to decision block 408, where a determination is made whether a first viewer has joined the multi-viewer event within a first threshold time after the start time of the event. As described herein, a viewer can utilize a portal, dashboard, or other user interface to access or join an event. In some embodiments, viewers may be enabled or authorized to join an event within a second threshold time prior to the start time of the event. In this way, viewers can join the event at relatively the same time. But if no viewers join the event prior to the first threshold time after the start time, then the system can infer that the start time was not a good time for the group of viewers associated with that event.

If a first viewer joins the event prior to the start time or within the first threshold time after the start time, then process 400 flows to block 410; otherwise, process 400 loops to block 404 to re-cluster the viewers. In various embodiments, the system utilizes the failure of the event to start as feedback to the clustering algorithms to indicate that the event was unsuccessful. The system can then re-cluster viewers and generate new multi-viewer events. This re-clustering may result in the same group of viewers and the same select content as the unsuccessful event, but with a new, different start time.

At block 410, the first viewer is set as the host for the multi-viewer event. As described herein, the presentation of the content to the host viewer is used as the current playback position of the content such that other viewer computer devices synchronize to the host viewer's presentation time. Moreover, the host viewer may have additional permissions, such muting viewers, setting reaction times or windows, etc.

In some embodiments, block 410 may be optional and may not be performed. Rather, the host viewer may be pre-selected by the system independent of which viewer joins the event first. For example, when the multi-viewer event is generated, a “super” viewer (e.g., a viewer that joins a select threshold percentage of events) may be set as the host viewer.

Process 400 proceeds next to block 412, where the multi-viewer event is started. In some embodiments, the multi-viewer event is started when the host viewer begins the presentation of the content selected for the event. In other embodiments, the system automatically initiates the presentation of the content to the host viewer.

After block 412, process 400 loops to block 404 to continue clustering viewers and generating multi-viewer events.

FIG. 5 shows a system diagram that describes one implementation of computing systems for implementing embodiments described herein. System 500 includes content distributor 102, content synchronization server 104, and viewer computer devices 120.

Content distributor 102 provides original content to the viewer computer devices 120. Content distributor 102 includes or has access to content 586, which stores one or more items of audiovisual content to be presented to viewers of viewer computer devices 120. This audiovisual content may be referred to as the original content or the first content being presented to viewers. The content distributor 102 includes other computing components that are not shown for ease of illustration. These computing components may include processors, memory, interfaces, network connections, etc., to perform at least some of the embodiments described herein.

Content synchronization server 104 receives, from a viewer computer device 120 of a host viewer, the current viewing position of original content from content distributor 102 being presented to the host viewer and distributes this current viewing position to viewer computer devices 120 of other viewers. In some embodiments, the content synchronization server 104 also receives viewer-reaction content from the viewer computer devices 120 and provides the viewer-reaction content to other viewer-computer devices 120 to create a socially annotated version of the original content provided by the content distributor 102.

One or more special-purpose computing systems may be used to implement content synchronization server 104. Accordingly, various embodiments described herein may be implemented in software, hardware, firmware, or in some combination thereof. In various embodiments, content synchronization server 104 is also referred to as a server computer or server computing device.

Content synchronization server 104 may include memory 530, one or more central processing units (CPUs) 544, I/O interfaces 546, other computer-readable media 550, and network connections 552.

Memory 530 may include one or more various types of non-volatile and/or volatile storage technologies. Examples of memory 530 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof.

Memory 530 is utilized to store information, including computer-readable instructions that are utilized by CPU 544 to perform actions and embodiments described herein. For example, memory 530 may have stored thereon content synchronization management module 532 and viewer-reaction content management module 534. The content synchronization management module 532 communicates with the viewer computing devices 120 to synchronize the presentation of the original content. The viewer-reaction content management module 534 receives viewer-reaction content from viewer computer devices 120 and provides the viewer-reaction content to other viewer computer devices 120.

Memory 530 also stores viewer-reaction content 536. Viewer-reaction content 536 stores one or more items of audiovisual content generated by the viewer computer devices 120. Each viewer-reaction content includes a viewer's reaction—video, audio, or both—that corresponds to an original content item stored in content 586 by content distributor 102. Viewer-reaction content may also include the viewer's reactions to other viewer-reaction content for the same original content, when the other viewer-reaction content is presented to the viewer along with the original content. In some embodiments, the viewer-reaction content for a particular original content may be combined with the original content such that a single data stream including the original content and the corresponding viewer-reaction content can be provided to a viewer computer device 120.

Memory 530 may also store other programs and data 538 to perform other actions associated with the operation of content synchronization server 104.

Network connections 552 are configured to communicate with other computing devices, such as viewer computer devices 120, content distributor 102, or other devices not illustrated in this figure. In various embodiments, the network connections 552 include transmitters and receivers (not illustrated) to send and receive data as described herein. I/O interfaces 546 may include a keyboard, audio interfaces, video interfaces, or the like. Other computer-readable media 550 may include other types of stationary or removable computer-readable media, such as removable flash drives, external hard drives, or the like.

Viewer computer devices 120 receive content from content distributor 102 and coordinate synchronization with a host viewer via content synchronization server 104. Viewer computer devices 120 may also receive viewer-reaction content of other viewers from content synchronization server 104 for presentation to a viewer of the corresponding viewer computer device 120. The viewer computer devices 120 also generate viewer-reaction content of the viewer of that particular viewer computer device 120 and provide it to the content synchronization server 104. One or more special-purpose computing systems may be used to implement each viewer computer device 120. Accordingly, various embodiments described herein may be implemented in software, hardware, firmware, or in some combination thereof.

Viewer computer devices 120 may include memory 502, one or more central processing units (CPUs) 514, display 516, I/O interfaces 518, other computer-readable media 520, network connections 522, camera 524, and microphone 526. Memory 502 may include one or more various types of non-volatile and/or volatile storage technologies, similar to what is described above for memory 530.

Memory 502 is utilized to store information, including computer readable instructions that are utilized by CPU 514 to perform actions and embodiments described herein. In some embodiments, memory 502 may have stored thereon content presentation module 204, content synchronization module 206, and viewer-reaction content generation module 208.

Content presentation module 204 receives original content from content distributor 102 and viewer-reaction content from content synchronization server 104 and displays or otherwise presents the content to a viewer of viewer computer device 120, such as via display 516 or other I/O interfaces 518. In various embodiments, content presentation module 204 combines or otherwise overlays the viewer-reaction content onto the original content. In some embodiments, content presentation module 204 analyzes the original content to determine when to record the viewer's actions and notifies the viewer-reaction content generation module 208 to record the viewer's reaction.

Content synchronization module 206 monitors and tracks the presentation of original content to the viewer of the viewer computer device 120. If the viewer is a host viewer, then any changes made to the presentation, such as fast forward, rewind, or skip, by the host viewer are transmitted to the content synchronization management module 532 of the content synchronization server 104. If the viewer is not the host viewer, then content synchronization module 206 receives presentation timing and synchronization updates from thee content synchronization management module 532 of the content synchronization server 104 and coordinates with the content presentation module 204 to keep the content presentation in sync with the host viewer.

Viewer-reaction content generation module 136 utilizes the camera 524 or the microphone 526, or both, to generate the viewer-reaction content by recording the viewer's reaction to the presentation of the original content or the other viewer-reaction content, or both. In some embodiments, viewer-reaction content generation module 208 receives instructions from content presentation module 204 to automatically record the record the viewer's reaction as specific timestamps or locations in the original content or to specific viewer-reaction content of other viewers. In other embodiments, the viewer of the viewer computer device 120 can interact with the viewer-reaction content generation module 208 via I/O interfaces 518 to provide input indicating when the viewer's reaction is to be recorded.

Memory 502 may also store viewer-reaction content 508, which temporarily stores the viewer-reaction content generated by viewer-reaction content generation module 208 prior to being provided to the content synchronization server 104. Memory 502 may also store other programs and data 510 to perform other actions associated with the operation of viewer computer device 120.

Display 516 is configured to provide content to a display device for presentation of the content to a viewer. In some embodiments, display 516 includes the display device, such as a television, monitor, projector, or other display device. In other embodiments, display 516 is an interface that communicates with a display device.

I/O interfaces 518 may include a keyboard, audio interfaces (e.g., microphone 526), other video interfaces (e.g., camera 524), or the like. Network connections 522 are configured to communicate with other computing devices, such as content distributor 102 content synchronization server 104 or other computing devices not illustrated in this figure. In various embodiments, the network connections 522 include transmitters and receivers (not illustrated) to send and receive data as described herein. Other computer-readable media 520 may include other types of stationary or removable computer-readable media, such as removable flash drives, external hard drives, or the like.

Although FIG. 5 illustrates the viewer computer device 120 as a single computing device, embodiments are not so limited. Rather, in some embodiments, a plurality of computing devices may be in communication with one another to provide the functionality of the viewer computer device 120. Such computing devices may include smart phones, tablet computers, laptop computers, desktop computers, televisions, projectors, set-top-boxes, content receivers, other computing devices, or some combination thereof.

For example, a viewer's television may receive original content (e.g., from a content distributor or from a reaction content server) and present it to the viewer. A smart phone can then capture the viewer's reactions while the viewer is watching the original content on the television. The television or a set-top-box coordinating the display of the content on the television (collectively referred to as a television) and the smart phone can communicate with each other to determine where in the original content the viewer-reaction content was captured. In some embodiments, the viewer can utilize one or more interfaces on the television or the smart phone to trigger the capture of a viewer reaction. The smart phone can provide the viewer-reaction content to the television for forwarding to the content synchronization server, or the smart phone may provide the viewer-reaction content directly to the reaction content server.

In some embodiments, the television may also receive viewer-reaction content from the content synchronization server for presentation to the viewer along with the original content. In other embodiments, the smart phone may obtain (via the television or from the reaction content server) the viewer-reaction content and present the viewer-reaction content on the smart phone to the viewer as the viewer is watching the original content on the television. In this way, the original content is not obstructed or changed by the viewer-reaction content.

Embodiments described herein may be further combined or modified to include additional functionality. The following paragraphs provide a brief discussion of such additional functionality—some of which are discussed in more detail elsewhere herein.

The viewer-reaction content may be stored on a remote server, such as content synchronization server 104, another reaction content server (not illustrated), or some other third-party content provider (including content distributor 102). The viewer-reaction content may be downloaded from content distributor 102 as the original content plays.

The viewer-reaction content may be manually recorded while the original content is playing. The viewer-reaction content may be automatically recorded while the original content is playing. The viewer-reaction content may be retrieved from a video buffer by user action after a recorded scene. The viewer-reaction content may be a text comment with optional image graphic, attachment or animation, and synced to a point on a timeline of the original content. The viewer-reaction content may also be an emoji or graphics reaction that the viewer chooses from a menu and is synced to a point on the timeline of the original content. The viewer-reaction content may be a sticker, where the viewer chooses a graphic from a menu and places is at a specific point on the screen, at a specific time during presentation of the original content to the viewer.

In some embodiments, the original content may be unmodified and timeline marks may be superimposed on the original content during presentation to a viewer based on information received from the content synchronization server 104. In other embodiments, the original content may be modified and marked along the original content timeline noting where viewer-reaction content takes place for one or a plurality of viewers. Timeline marks, where added to the original content or superimposed during display, may change size based on the length of viewer-reaction content or how many different viewer-reaction content occurs at that point in time. The viewer may select a timeline mark that jumps both the original content and the viewer-reaction content forward or back to that moment. Different colored or styled timeline marks may indicate a status of viewer-reaction content, such as saved, saving, unsaved, from—me, from—others etc. Viewer-reaction content may be pre-fetched and buffered several seconds ahead of time to make sure they play in-sync with the original content.

Viewer-reaction content may be presented by animating it into view, such as by fading in, pin wheeling in from one side of the screen, etc. The viewer-reaction content may itself be animated to indicate progress or time left in the viewer-reaction content (e.g., a circle border around the video clip fills in as it is presented to the viewer). Clicking or tapping on viewer-reaction content as it is presented may restart the viewer-reaction content at the beginning and rewinds the original content to the sync point. Presentation of viewer-reaction content may have an extra button for indicating that the viewer “likes” the viewer-reaction content, which can be aggregated with other “likes” to determine a priority of the viewer-reaction content. Clicking viewer-reaction content as it is presented may open additional options to perform on the viewer-reaction content, such as sharing or replying.

If presentation of two viewer-reaction content overlap on the timeline of the original content, the second clip may play on mute until the first clip finishes, it then unmutes. If the original content is paused, all currently visible viewer-reaction content may be paused. When presentation of the original content resumes, presentation of the viewer-reaction content may also resume. If the presentation of the original content pauses to buffer, presentation of any viewer-reaction content may also pause. The viewer-reaction content resumes when the original content resumes.

A camera viewfinder may provide a preview of the viewer's reactions and activates when the original content starts playing and is overlaid on top of the original content. The camera feed may be kept in a 10 second (or other timeframe) buffer to be used when the viewer activates the capture of the viewer-reaction content. The buffer may be cleared every 10 seconds (or other timeframe) and restarted. The previous buffer may be saved so there is always available buffer. If the viewer activates the viewer-reaction content and the current buffer is less than 4 seconds (or other timeframe), the previous buffer may be used with an offset mark. The viewer can activate the different types of viewer-reaction content by clicking on the viewfinder, such as 1-click, click-and-hold, double-click, etc. Additional camera settings may be utilized to enable the viewer to choose from available camera and audio devices as well as the aspect ratio, size and shape of the video clips for the viewer-reaction content. There may be additional buttons for activating text, emoji and sticker viewer-reaction content.

When new viewer-reaction content is created, a preview of the viewer-reaction content may be shown near the viewfinder. The preview may play back immediately, on mute, and out-of-sync with the original content. Clicking the preview may cause the viewer-reaction content to restart, unmute and the original content to rewind to the sync point. When the preview finishes, a timer indicator counts down for 5 seconds (or other timeframe) after which the viewer-reaction content is saved to the server.

When new viewer-reaction content is created, an “unsaved” marker may be added to the timeline in the original content. The marker may change to “saved” when the viewer-reaction content is uploaded to the server. Previews may have a “delete” button that erases the viewer-reaction content, removes its marker from the timeline and cancels the upload. When a preview is saved, it can be animated to the section of the screen where standard viewer-reaction content is displayed. Newly saved viewer-reaction content may become instantly available to other viewers watching the same original content.

Viewers can indicate that the original content should pause when previous viewer-reaction content is presented. When the previous viewer-reaction content ends, the original content resumes. The volume of the original content playing may be automatically lowered when the previous viewer-reaction content is presented to the viewer and is restored when the previous viewer-reaction content finishes. Facial recognition may be used to zoom in on faces and frame faces in video Viewer-reaction content. Analysis of captured video or audio may be used to trigger creation or generation of viewer-reaction content.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system, comprising:
a content synchronization server that stores synchronization information for a multi-viewer event, the content synchronization server includes a third memory that stores third computer instructions and a third processor that, when executing the third computer instructions, performs third actions, the third actions including:
receiving a plurality of viewing preferences for a plurality of viewers, the plurality of viewers includes a first viewer and a second viewer;
generating a plurality of groups of viewers from the plurality of viewers based on viewing preferences for each of the plurality of viewers, wherein the plurality of viewers includes the first viewer and the second viewer in a same group;
generating a multi-viewer event for the first viewer and the second viewer to view selected audiovisual content;
sending an invitation to the first viewer and to the second viewer to join the multi-viewer event at a defined start time;
a first viewer computer device of the first viewer associated with the multi-viewer event, the first viewer computer device includes a first memory that stores first computer instructions and a first processor that, when executing the first computer instructions, performs first actions, the first actions including:
in response to the first viewer joining the multi-viewer event:
receiving a first instruction from the content synchronization server for the first viewer computer device to obtain the selected audiovisual content for presentation to the first viewer;
in response to receiving the first instruction, accessing a first subscription to obtain first audiovisual content indicative of the selected audiovisual content from a content distributor;
presenting the first audiovisual content to the first viewer of the first viewer computer device during the multi-viewer event;
receiving a command from the first viewer to interact with the first audiovisual content;
generating the synchronization information based on the received command; and
providing the synchronization information to the content synchronization server; and
a second viewer computer device of the second viewer associated with the multi-viewer event, the second viewer computer device includes a second memory that stores second computer instructions and a second processor that, when executing the second computer instructions, performs second actions, the second actions including:
in response to the second viewer joining the multi-viewer event:
receiving a second instruction from the content synchronization server for the second viewer computer device to obtain the selected audiovisual content for presentation to the second viewer;
in response to receiving the second instruction, accessing a second subscription to obtain second audiovisual content indicative of the selected audiovisual content from the content distributor independent of the first viewer computer device obtaining the first audiovisual content during the multi-viewer event, the second audiovisual content is the same as the first audiovisual content;
receiving the synchronization information from the content synchronization server; and
presenting the second audiovisual content to a second viewer of the second viewer computer device based on the received synchronization information.

2. The system of claim 1, wherein the first processor, when executing the first computer instructions to receive the command from the first viewer, performs further actions, the further actions including at least one of:
receiving a fast forward command from the first viewer;
receiving a rewind command from the first viewer; or
receiving a skip command from the first viewer.

3. The system of claim 1, wherein the first processor, when executing the first computer instructions to generate the synchronization information, performs further actions, the further actions including:
determining a current playback position of the first audiovisual content in response to the received command; and
generating the synchronization information to include the current playback position of the first audiovisual content.

4. The system of claim 1, wherein the second processor, when executing the second computer instructions, performs further actions, the further actions including:
determining if the synchronization information is associated with a pause command or a rewind command; and
in response to determining that the synchronization information is associated with the pause command or the rewind command:
determining a previously presented portion of the second audiovisual content;
buffering a next portion of second audiovisual content; and
pausing or rewinding the second audiovisual content based on the pause command or the rewind command.

5. (canceled)

6. The system of claim 1, wherein the third processor, when executing the third computer instructions, performs further actions, the further actions including:
receiving an indication that the first viewer is first to join the multi-viewer event; and
setting the first viewer as a host to control playback of the first audiovisual content.

7. The system of claim 1, wherein the third processor, when executing the third computer instructions, performs further actions, the further actions including:
scheduling the multi-viewer event for the first viewer and the second viewer based on viewing preference of the first viewer and the second viewer; and
in response to the first viewer and the second viewer not joining the multi-viewer event within a threshold time after the defined start time of the multi-viewer event, rescheduling the multi-viewer event.

8. The system of claim 1, wherein the third processor, when executing the third computer instructions, performs further actions, the further actions including:
receiving, from the first viewer computer device, a reaction content of a reaction of the first viewer captured during presentation of the first audiovisual content to the first viewer; and
providing the reaction content to a third viewer computer device to present a combination of the reaction content along with third audiovisual content to a third viewer of the third viewer computer device, the third audiovisual content is same as the first audiovisual content.

9. A method, comprising:
receiving a plurality of viewing preferences for a plurality of viewers, the plurality of viewers includes a first viewer and a second viewer;
generating a plurality of groups of viewers from a plurality of viewers based on viewing preferences for each of the plurality of viewers, wherein the plurality of viewers includes a first viewer and a second viewer in a same group;
generating a multi-viewer event for the first viewer and the second viewer, wherein the multi-viewer event identifies select content and a start time;
prior to the start time, sending an invitation to the first viewer and to the second viewer to join the multi-viewer event at the start time;
setting the first viewer as a host;
employing the first viewer to log into a content distributor from a first viewer computer device to obtain and present first content indicative of the select content;
employing the second viewer to separately log into the content distributor from a second viewer computer device to obtain and present second content indicative of the select content independent of the first viewer computer device obtaining the first content;
receiving a command from the first viewer to interact with the first content;
providing synchronization information to the second viewer computer device based on the received command to enable the second computer device to present the second content based on the synchronization information.

10. The method of claim 9, wherein receiving the command from the first viewer includes at least one of:
receiving a fast forward command from the first viewer;
receiving a rewind command from the first viewer; or
receiving a skip command from the first viewer.

11. The method of claim 9, further comprising:
determining a current playback position of the first content in response to the received command; and
generating the synchronization information to include the current playback position of the first content.

12. The method of claim 9, further comprising:
determining if the synchronization information is associated with a pause command or a rewind command;
in response to determining that the synchronization information is associated with the pause command or the rewind command:
determining a previously presented portion of the second content;
buffering a next portion of second content; and
pausing or rewinding the second content based on the pause command or the rewind command.

13. (canceled)

14. The method of claim 9, wherein setting the first viewer as the host comprises:
receiving an indication that the first viewer is first to join the multi-viewer event; and
setting the first viewer as the host to control playback of content indicative of the select content.

15. The method of claim 9, wherein generating the multi-viewer event comprises:
scheduling the multi-viewer event for the first viewer and the second viewer based on viewing preference of the first viewer and the second viewer; and
in response to the first viewer and the second viewer not joining the multi-viewer event within a threshold time after a start time of the multi-viewer event, rescheduling the multi-viewer event.

16. The method of claim 9, further comprising:
capturing a reaction of the first viewer during presentation of the first content to the first viewer; and
presenting the reaction along with third content indicative of the select content to a third viewer.

17. A non-transitory computer-readable medium having stored contents that, when executed by a processor of a computing system, cause the computing system to:
receive a plurality of viewing preferences for a plurality of viewers, the plurality of viewers includes a first viewer and a second viewer;
cluster the plurality of viewers into a plurality of clusters based on the plurality of viewing preferences, wherein the first viewer and the second viewer are in a same cluster;
generate a multi-viewer event for the first viewer and the second viewer;
select content to be presented during the multi-viewer event;
set a start time for the multi-viewer event;
send an invitation to the first viewer and to the second viewer to join the multi-viewer event at the start time;
set the first viewer as a host; and
in response to the first viewer and the second viewer joining the multi-viewer event:
instruct a first viewer computer device of the first viewer to obtain the selected content for presentation to the first viewer;
independently instruct a second viewer computer device of the second viewer to obtain the selected content for presentation to the second viewer;
during presentation of presenting the selected content to the first viewer, receive synchronization information from the first viewer computer device, wherein the synchronization information is associated with a command from the first viewer to interact with the selected content; and
provide the synchronization information to the second viewer computer device for the second viewer computer device to synchronize presentation of the selected content to the second viewer.

18. The non-transitory computer-readable medium of claim 17, wherein executing the stored contents by the processor of the computing system further causes the computing system to:
determine a current playback position of the selected content in response to the received command; and
generate the synchronization information to include the current playback position of the selected content.

19. The non-transitory computer-readable medium of claim 17, wherein executing the stored contents by the processor of the computing system to set the first viewer as the host further causes the computing system to:
receive an indication that the first viewer is first to join the multi-viewer event; and
set the first viewer as the host to control playback of the selected content.

20. The non-transitory computer-readable medium of claim 17, wherein executing the stored contents by the processor of the computing system further causes the computing system to:
in response to the first viewer and the second viewer not joining the multi-viewer event within a threshold time after the start time of the multi-viewer event, rescheduling the multi-viewer event.
